(19) United States
(12) Patent Application Publication
(10) Pub. No.: US 2012/0124482 A1
(43) Pub. Date: May 17, 2012

(54) METHODS AND SYSTEMS FOR MONITORING AND ENCOURAGING PERSONAL DREAM ACHIEVEMENT

(76) Inventors: Kenneth D. RAY, Seattle, WA (US); Christopher Cox, Seattle, WA (US)

(21) Appl. No.: 13/293,071

(22) Filed: Nov. 9, 2011

Related U.S. Application Data
(60) Provisional application No. 61/411,495, filed on Nov. 9, 2010.

(51) Int. Cl. G06F 3/048; G06F 15/16

(52) U.S. Cl. 715/751; 715/780

(57) ABSTRACT

Methods and systems are provided for use in monitoring and encouraging the attainment of personal dreams. Users can publish dreams and action steps to online social networks and receive comments related thereto. Third-party users can write suggestions in connection with the dreams or action steps to help the user achieve the dreams. Anonymous feeds regarding the dreams and related actions can be sent to target sites as a function of user identity.

### CROSS-REFERENCE TO RELATED APPLICATION(S)

This application claims the benefit of U.S. provisional patent application Ser. No. 61/411,495, filed Nov. 9, 2010, which is incorporated herein by reference in its entirety.

### BACKGROUND

1. Field of the Disclosure

The present disclosure relates generally to methods and systems for encouraging, monitoring, and focusing on personal “dream” achievement.

2. Description of Related Art

Personal “dreams,” or goals, are often difficult to achieve on multiple levels. First, the term “dream,” can imply an extremely desirable circumstance, far removed from a person's current circumstances, and this alone can be discouraging and daunting to the person and cast the dream in a remote light. On top of that, a dream may be in conflict with the instincts or habits that a person forms in response to the practical realities of her daily life.

For some people, extreme self motivation and desire can see them through doubts and lead them to achieving their personal dreams. However, for many people, this is difficult. For those people, it can be desirable to have tools to help guide them through a process for accomplishing dreams, and to help provide encouragement, input, and direction for achieving their dreams.

### BRIEF SUMMARY OF THE DISCLOSURE

In some embodiments of the present disclosure, computer implemented methods for monitoring and encouraging the attainment of personal dreams for a user are provided. A user can establish an account with a remote server containing instructions for generating and controlling an online accessible graphical user interface (“GUI”) for use in displaying and transmitting various aspects of the present disclosure.

In some embodiments, text fields are provided by the GUI for use in describing dreams. Written descriptions of dreams are entered in the fields and stored. A plurality of text fields for use in describing action steps for attaining the dreams are displayed. A plurality of written descriptions describing different action steps for attaining the dreams, are stored. Graphical selectors can be displayed in association with the action steps for use in designating when the action steps are, among other things, active or complete.

The user can be prompted to create images to be associated with the description of dreams. The digital images can be stored in association with the description of the dreams.

In some embodiments, text fields are provided for use by third-party users for entering suggestions related to the dreams or action steps, and the suggestions can be stored in association with the dreams or corresponding action steps.

In some embodiments, the dream descriptions and actions step descriptions, among other things, can be published to one or more online social networks via profiles that are pre-associated with the user's account on the server of the present disclosure,

In addition, anonymous feeds containing transmitted items such as dream descriptions, action steps, comments or suggestions can be transmitted to third-party websites, without displaying the originator of the related dream or action step. In some embodiments, the target website to which the feed is sent is a function of the identity of the user to whose account the transmitted item relates.

### BRIEF DESCRIPTION OF THE DRAWINGS

FIG. 1 is simplified diagram of a system of the present disclosure including one or more general purpose computers connected to a global computer network, such as the Internet, and one or more servers, on which instructions for carrying out various embodiments of the present disclosure can reside.

FIG. 2 is a flow chart showing some steps for an embodiment of the present disclosure.

FIG. 3 is a continuation of the flow chart in FIG. 2.

FIGS. 4-27 illustrate screen shots from a graphical user interface for a user in some embodiments of the present disclosure.

### DETAILED DESCRIPTION OF PREFERRED EMBODIMENTS

In the following description, certain specific details are set forth in order to provide a thorough understanding of various embodiments of the disclosure. However, upon reviewing this disclosure, one skilled in the art will understand that the disclosure may be practiced without many of these details. In other instances, some well-known structures and methods associated with the Internet, computers, network systems and online social networks, have not been described in detail to avoid unnecessarily obscuring the descriptions of the embodiments of the disclosure.

Section or paragraph headings as used herein are intended only to assist the reader in following the organization of this disclosure and are not intended to be limiting or restrictive unless otherwise expressly indicated.

The descriptions of examples of the present disclosure provided herein are not intended to be restrictive unless otherwise indicated. The drawings include example information depicted for illustrative purposes. Also, various examples set forth below describe a server 4 usable for processing instructions, and delivering signals to users on a network; however, as will be appreciated by those skilled in the art upon reviewing this disclosure, multiple servers 4, or remote computing and storage units, may be used to provide aggregate or distributing processing capacity and storage capacity, either in parallel or in a distributed computing context. Furthermore, in some embodiments, software application components of the present disclosure may be stored on the user computer, or other computing device, such as a wireless device (e.g., cell phone, tablet) to execute various tasks associated with the embodiments of the present disclosure, either entirely, or in conjunction with one or more applications residing on the server 4, as will be appreciated by those skilled in the art after reviewing this disclosure.

In the present description, the terms “about” or “consisting essentially of” mean±20% of the indicated range, value, or structure, unless otherwise indicated. It should be understood that the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously, which terms and variants thereof are intended to be construed as non-limiting.

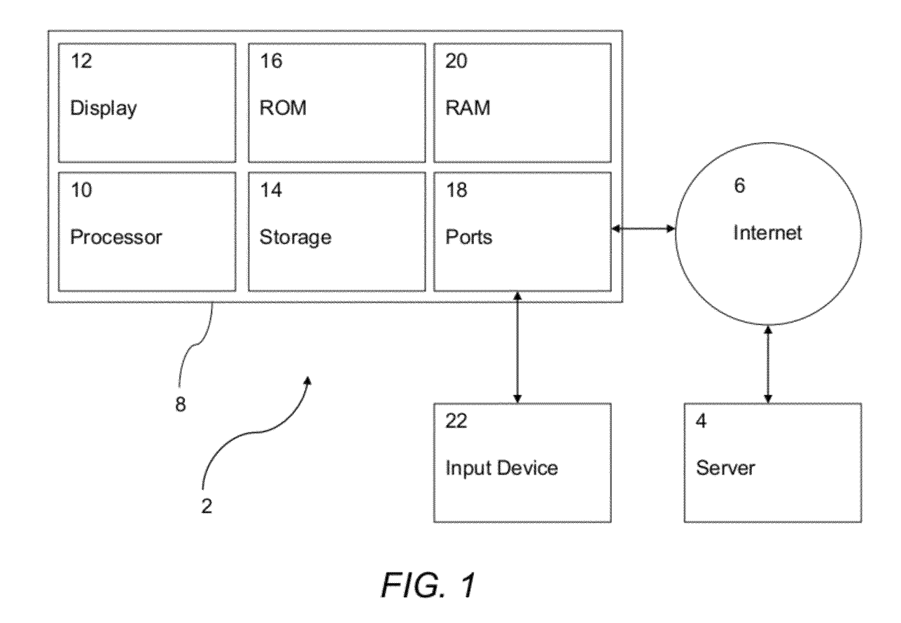

Referring to FIG. 1, various embodiments of the present disclosure can include a system 2, hosted by one or more servers 4 and can be remotely accessible over a global network 6 (e.g., the Internet), a local area network, or wide area network, or a combination thereof by a plurality of clients. The server 4 can comprise one or more computers, or other devices or systems capable of processing instructions and information and communicating over the network 6.

FIG. 1 further shows one or more general purposes computers 8 communicatively coupled to a server 4 via a global network 6 (e.g., Internet). Each computer 8 can include a processor 10, display system 12, non-volatile storage device 14, ROM 16, a plurality of communications ports 18 and communications interfaces, and RAM 20. The plurality of communication ports 18 on computer 8 can receive control signals from input devices 22 (e.g., keyboard or mouse) and various communications interfaces can be provided to enable communications over the network 6. As will be appreciated by those skilled in the art after reviewing this disclosure, the computers used by users can also be other computing devices, such as, for example, personal data devices or cell phones, having processors, displays, input devices, and communications capabilities for communicating on a network in various embodiments of the present disclosure.

In some embodiments of the present disclosure, a user of computer 8 can access a graphical user interface (“GUI”) of the present disclosure, which may be hosted as a website on server 4 of the present system 2. The website may include, among other things, a sign-up screen for use in establishing a user account, which may be associated with a user name and password for secured access. Once a user has established an account, the user can execute the following steps, without restriction to the order in which the steps are described below, and without requiring that all of the following steps be included. Furthermore, not all steps need to be completed at one sitting. Since the methods and systems described below are provided for tracking and encouraging dreams, short or long stretches of time may exist between entry of data, and other actions may be taken in between. In addition, although a user must initially create a dream, and must thereafter create at least one action step, as described below, various other steps of the methods may be carried out in different orders (e.g., dreamboard may be created later after creating and accomplishing one or more action steps, dreams may be edited even after they are shared, etc.).

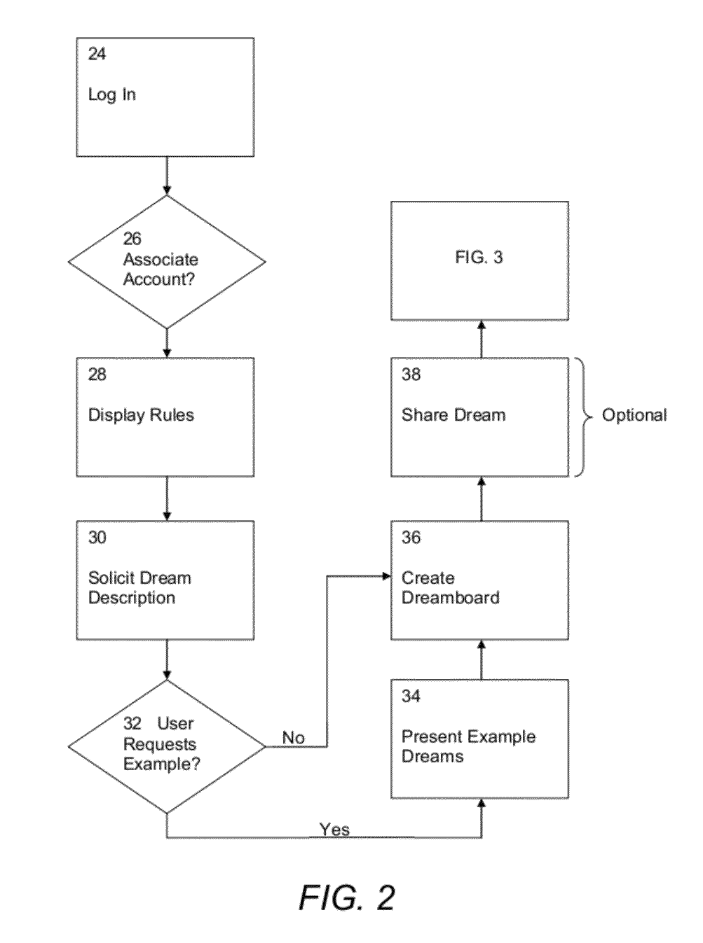

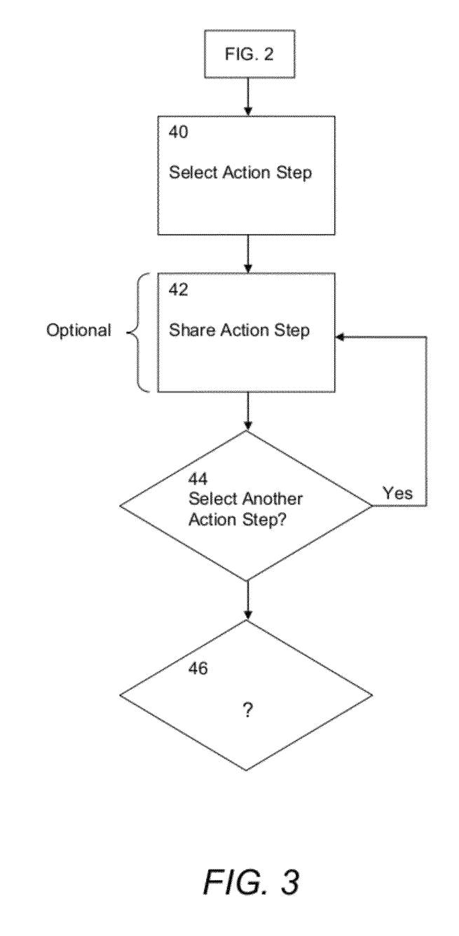

Referring to FIG. 2, at step 24, a user logs into the website by providing a user name and password. The user may be required to provide an email address when establishing her account.

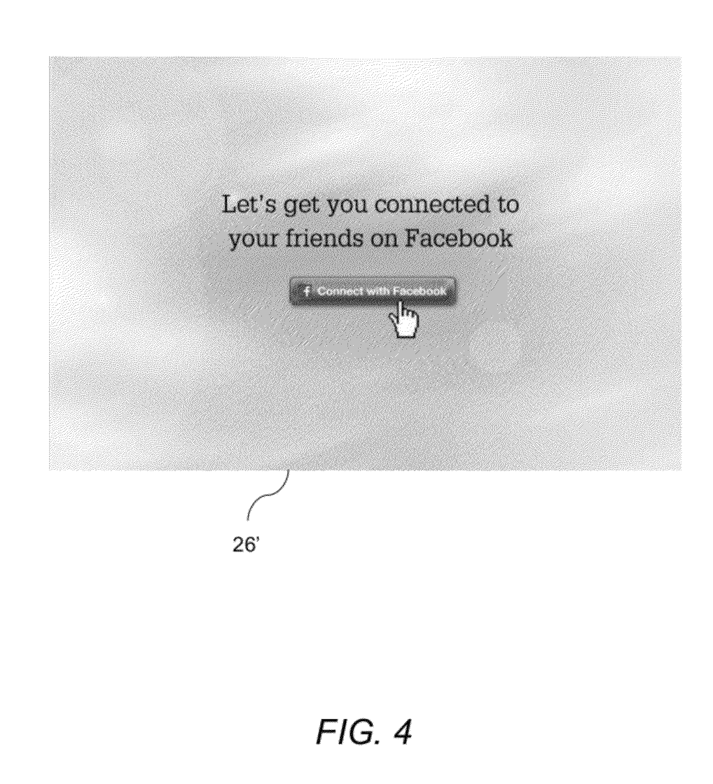

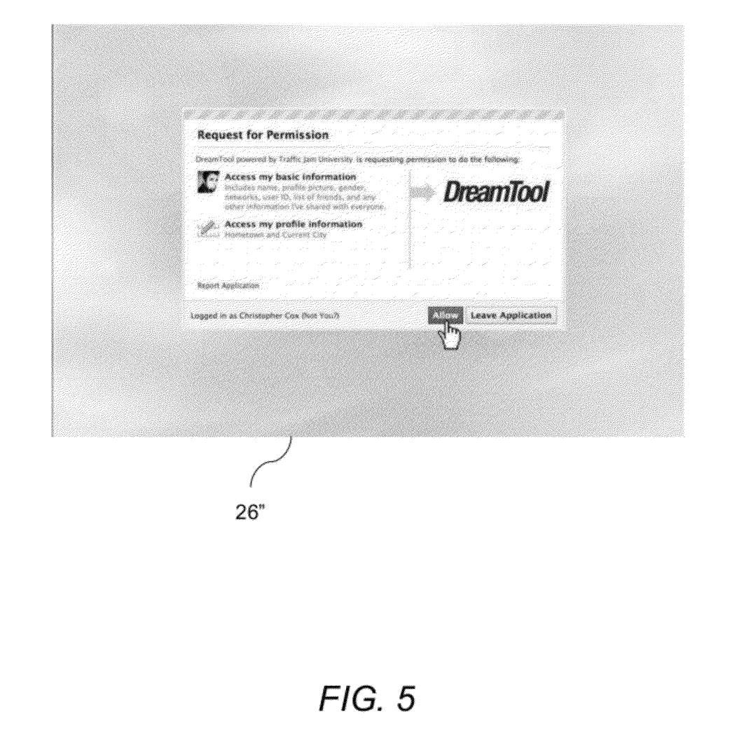

Referring to FIG. 2, at step 26 (see, also, screenshot 26′ of FIG. 4), the user can request to, or be presented with a request to, associate the user's newly formed account with the user's list of friends on one or more online social networks, such as, for example, without limitation, FACEBOOK™. As shown in screenshot 26″, the user can be requested to allow association between the user's account on the server 4 (or host) and the user's account on one or more online social networks (e.g., based on the user's email address).

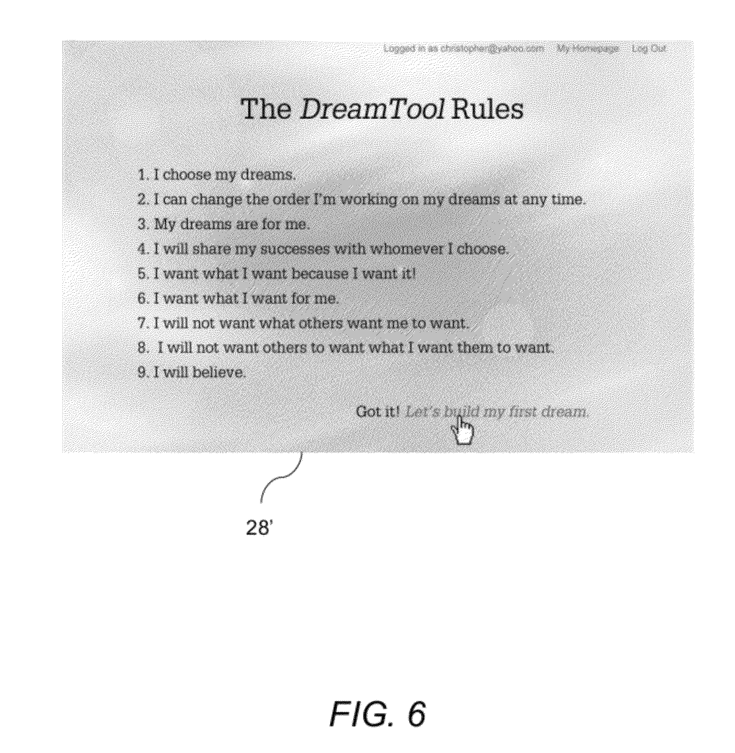

Referring to FIG. 2, at step 28 (see, also, screenshot 28′ of FIG. 6) the user can be presented with a set of rules displayed for use of the website.

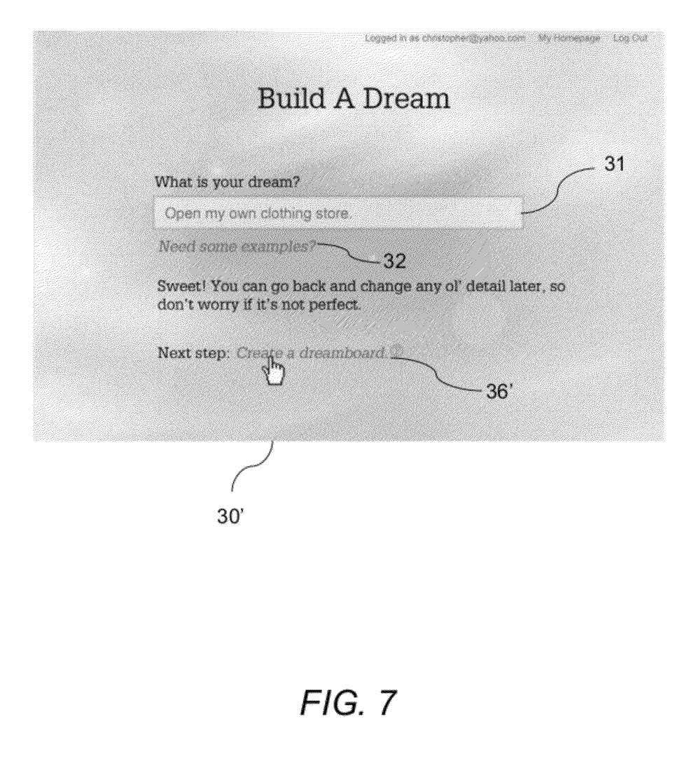

Referring to FIG. 2, at step 30 (see, also, screenshot 30′ of FIG. 7), the user can be presented with a request to enter a title or description of a dream of the user. As shown in FIG. 7, an example inquiry presented to the user at this step can be, “What is your dream?” Field 31 can be provided for entry of a dream description or title.

Referring to FIG. 2, at step 32 (see, also, screenshot 30′ of FIG. 7), the user can select dream examples by clicking a graphical or character link 32, shown immediately below a character field. In some embodiments, the link 32 can be displayed as an inquiry, “Need some examples?” If the user selects to see examples, at step 34, an instruction residing on the server 4 can present the user with example descriptions for dreams. These examples can be examples collected from other users. In some embodiments of the present disclosure, when the user selects to receive examples, a menu can be displayed (not illustrated in the figures) including a listing of categories of dreams, such as, for example, “business,” “art and music,” “personal relationships,” “physical fitness,” “spiritual,” etc. A user can select a category and then subcategories can be presented by the system 2. For example, under the category, “business dreams,” the subcategories can include, without limitation, for example, “restaurants,” “consulting,” “printing,” etc., arranged in alphabetical order. In some embodiments, once a subcategory is selected, sub-subcategories can be selected. For example, under the subcategory “consulting,” the sub-subcategories presented can include, “open consulting firm,” “become consultant,” etc. A user can select a dream from these examples, and the system 2 can backfill a dream description into field 31, FIG. 7, for review by the user, the description being based on the examples selected by the user. The user can edit the dream description once it is backfilled.

In some embodiments of the present disclosure, example dreams are automatically displayed to a user when the user fails to enter a dream description for a period of time longer than a pre-designated period. The example dreams can be dreams described by other users, or can be randomly presented from a database containing example dreams. The pre-designated period can be five (5) minutes or ten (10) minutes, or shorter than five (5) minutes or longer than ten (10) minutes. In other example embodiments of the present disclosure, a user can select to view dream descriptions provided by other users, provided that the dream descriptions were not designated as “private” by the user.

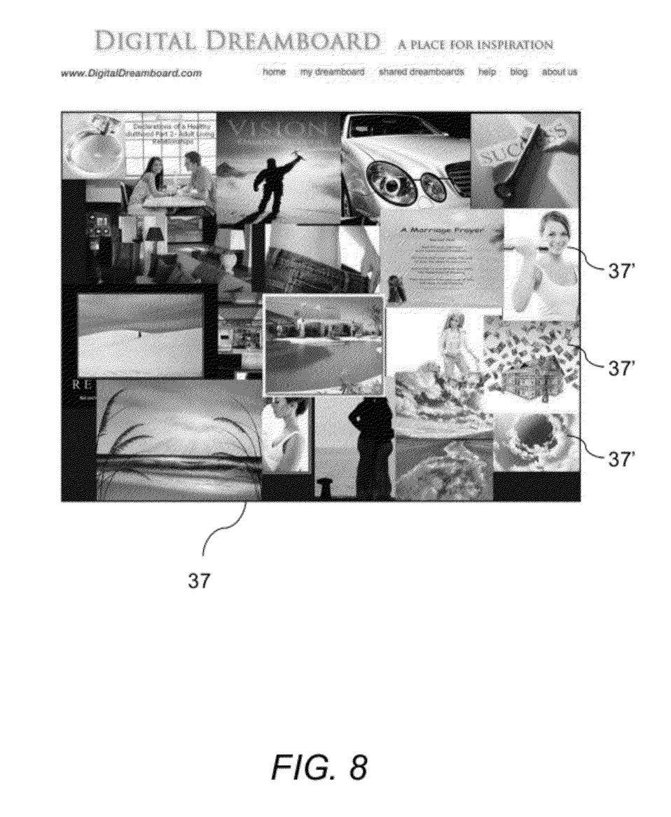

Referring to FIG. 2, at step 36, the user can select to create a digital dreamboard by, for example, clicking the link 36′ (see, also, FIG. 7), which can be displayed as a graphical representation of the phrase, “Next step: Create a dreamboard.” Once a user selects to create a dreamboard, in some embodiments, the user can be presented with a representation of a graphical board 37 (see, also, FIG. 8), on which the user can post images 37′ for creating the dreamboard 37. The user can also be presented with the option of browsing images stored on the user's computer 8 for import into the graphical board or dreamboard 37, or stored on an image library associated with server 4. As will be appreciated by those skilled in the art after reviewing this disclosure, the dreamboard 37 is a widely used and relatively popular tool to help users visualize their dreams.

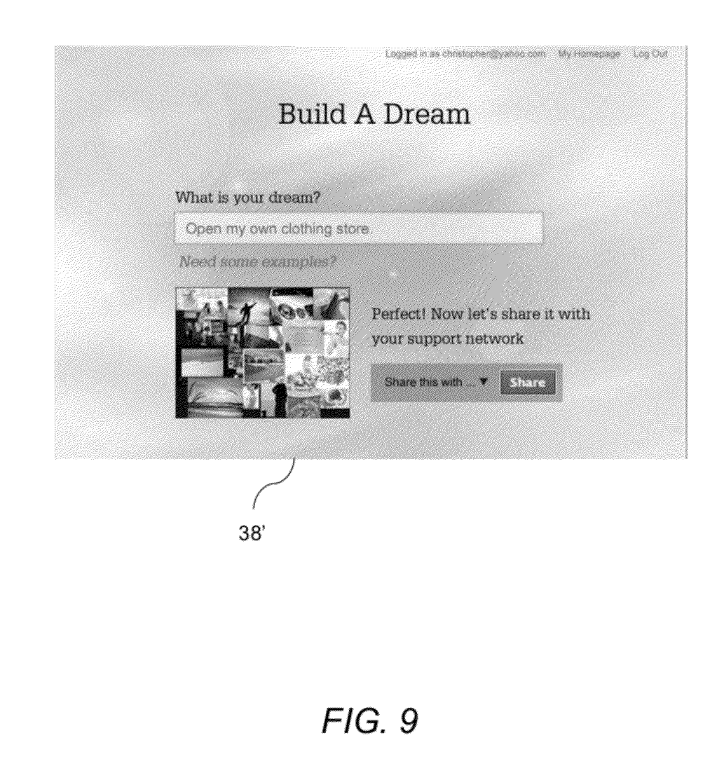

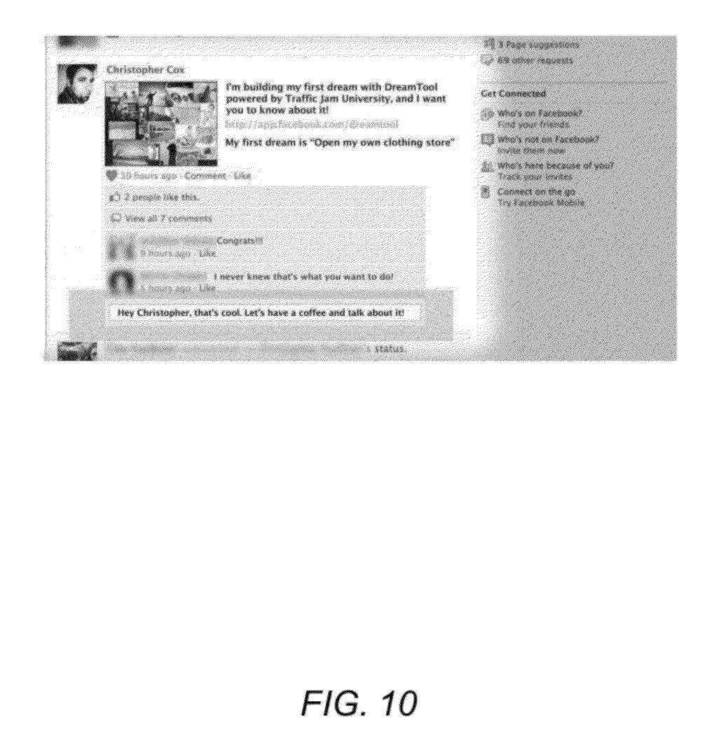

Referring to FIG. 2, at step 38 (see, also, screenshot 38′, FIG. 9), a user can authorize the system 2, on FIG. 1, to share the dream with others, such as, for example, to one or more online social networks of which the user is a member such as, for example, FACEBOOK™. This act of sharing can establish a support group for the user for the dream. In some embodiments, for each particular dream entered by the user, the user has discretion on whether or not to share the dream with any others, or with the user's entire online social network (which can be spread out over multiple online social networking websites). If the user elects to share the dream, information regarding the dream can be automatically posted on the user's profile “wall” at the social network sites (e.g., FACEBOOK™) for viewing and comment by the user's friends. See, e.g., FIG. 10. As will be appreciated by those skilled in the art, the user's account on server 4 can be associated with multiple online social network sites on which the user has one or more accounts. In this manner, when the user elects to share any data described in this disclosure, such as dreams or actions steps, with the user's network, a single touch of a “share” button can cause the data to be shared in each of the user's online social networks.

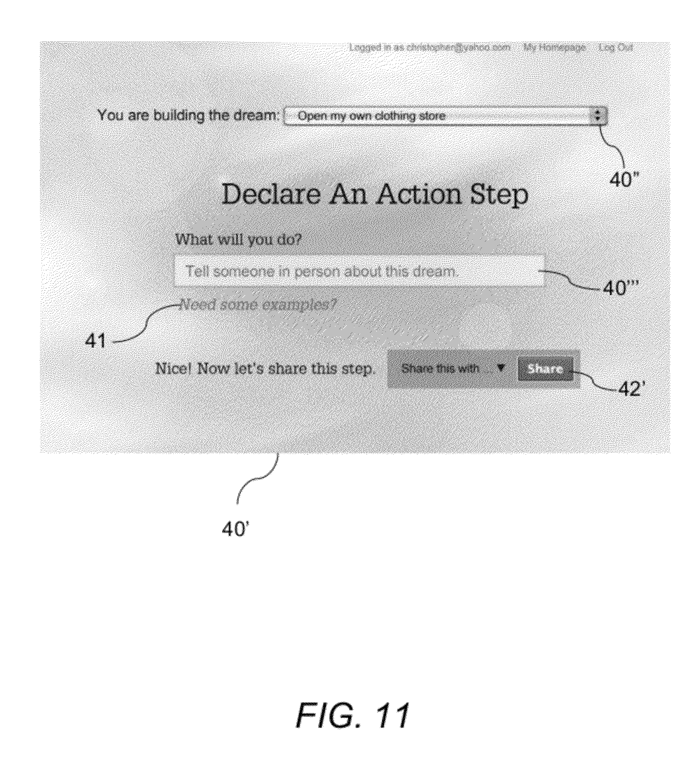

At step 40, (see, also, FIG. 11, screenshot 40′), the user can select or describe an Action Step to take to achieve their dream. The user can have declared multiple dreams and is required to select a particular dream before entering an action step to associate with the dream. The user can select the dream for which to provide an action step, by first selecting the dream using the scrollable list 40″, FIG. 11. Once selected, the user can enter an “action step,” at field 40′″. Similar to dream selection, the user can directly describe an action step at the user's discretion in field 40′″, or select to see example action steps by selecting link 41, displayed in textual form as “Need some examples?”

At step 42, the user can select to share the action step, such as by clicking on graphical button 42′. If the user selects to share the action step, it can be shared with the same group (through the same associations or designations) to which the corresponding dream is shared, or can be shared to a modified group, at the selection of the user.

At step 44, the user can select another action step for the dream and continue to create actions steps until the dream is accomplished.

At step 46, the user has a number of options, such as, for example, without limitation, creating another action step, editing the dream, viewing all dreams associated with the user account, or viewing all actions steps for the particular dream.

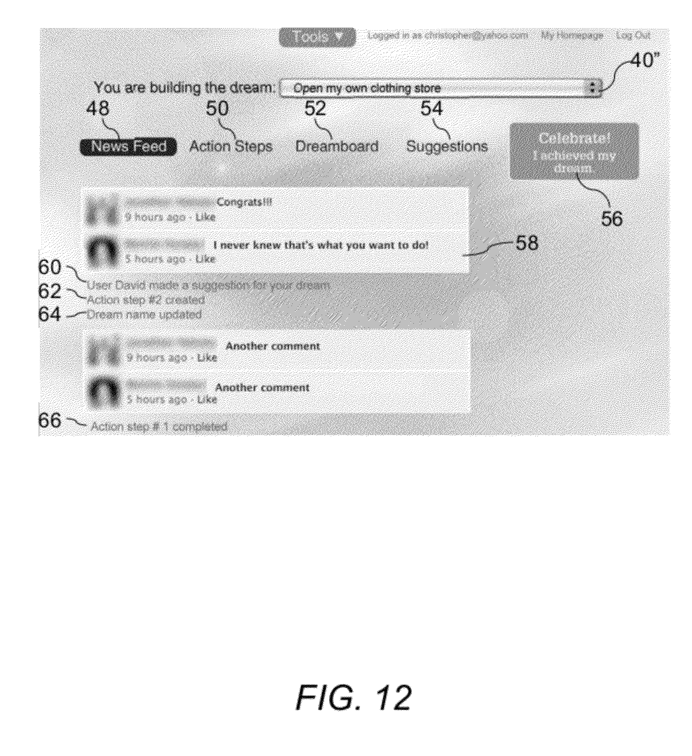

As shown in FIG. 12, in some embodiments of the present disclosure, a user can select various functions associated with viewing a “News Feed” 48, “Action Steps” 50, the “Dreamboard” 52, and “Suggestions” 54. For example, if a user selects a previously entered dream title, “Open my own clothing store,” in the scrollable list 40,″ each of graphical indicia 48, 50, 52 and 54 can be selected to view or access functions associated with the dream selected in the scrollable list 40″. In some embodiments, the functions associated with the indicia 48, 50, 52, 54 include:

(a) News Feed 48:

In some embodiments, when this graphical indicia, News Feed 48, is selected, third-party comments 58 and suggestions 60, action step creation data 62 or action step completion data 66, and links to dream edits 64 can all be displayed to the user through a single screen in the form of a list, such as that shown in FIG. 12. The list can be chronological by time/day of the particular event. All such events are displayed in relation to the dream selected on the scrollable list 40″.

The comments 58 can be fed or imported from online social networking sites (e.g., FACEBOOK) on which the dream has been posted, as will be appreciated by those skilled in art after reviewing this disclosure. The suggestions 60 can be specific advice given by others, which can be collected directly from third-party users through the website hosted by the server 4. In some embodiments, the suggestions can be provided by third-party users that have established user accounts on the server 4, wherein the third-party users have a prior association with the user through another online social network or are specifically designated by the user as having permission to provide suggestions. In other embodiments, the suggestions can be restricted to only a select group individually picked by the user. Such suggestions from others may also be accepted by the user, and thus that user can promote the suggestion to an action step for the user to complete. Also, as action steps are completed or created, they can be listed in the News Feed list.

(b) Action Steps 50:

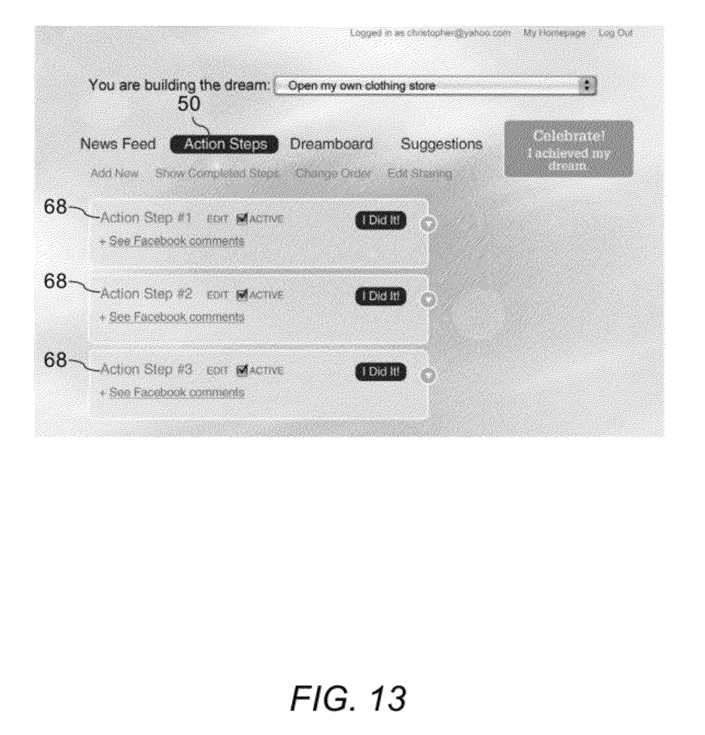

Referring to FIG. 13, in some embodiments of the present disclosure, when the Action Steps 50 graphical indicia is selected, all actions steps associated with the currently selected dream are displayed.

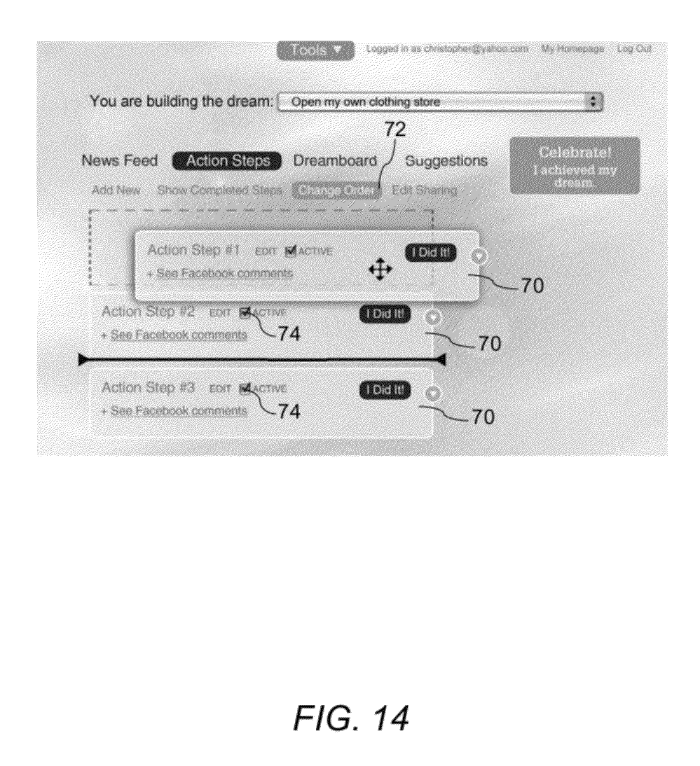

As shown in FIG. 14, action step panels 70 can be graphically reordered at the discretion of the user, by activating the Change Order 72 graphical button 72. Thereafter, action step panel 70 can be reordered by dragging and dropping the panel 70 to a location in the order as desired. All actions steps can be designated as “active” in their individual panels, such as by, for example, placing a cursor on a corresponding graphical box 74 and clicking the box to activate the action step 68. The default setting for an action step 68 is active after being created unless otherwise deactivated by, for example, un-checking the corresponding graphical box 74. In some embodiments, an action step needs to be completed before action steps that come after it in the order of arrangement can be completed.

In some embodiments of the present disclosure, dream descriptions for a user can also be viewed in a list in which the dreams have a particular order that may reflect the order of priority assigned to the dreams by the user. The dreams may be re-ordered at the discretion of the user. For example, the dreams may be presented in graphical panels that can be selectively graphically re-ordered, similar to manner in which the action step panels are re-ordered in the example described above.

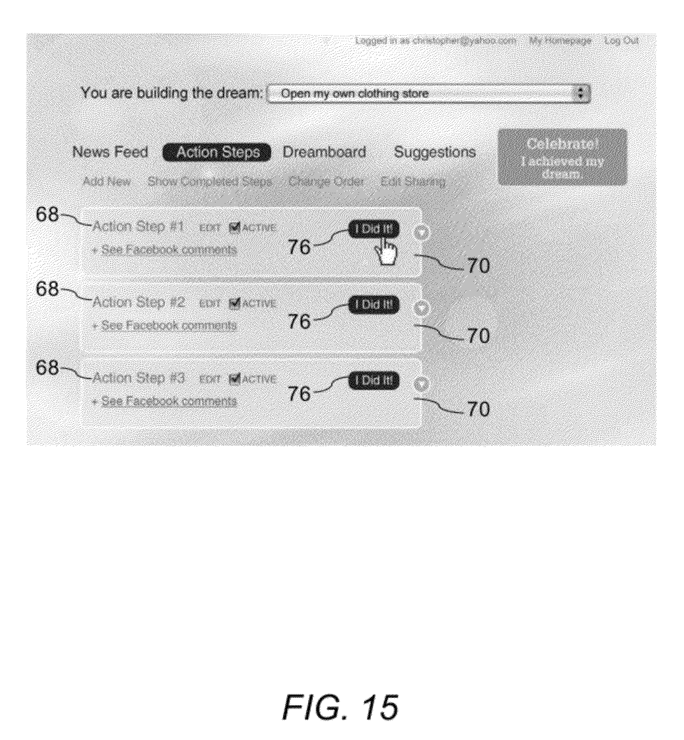

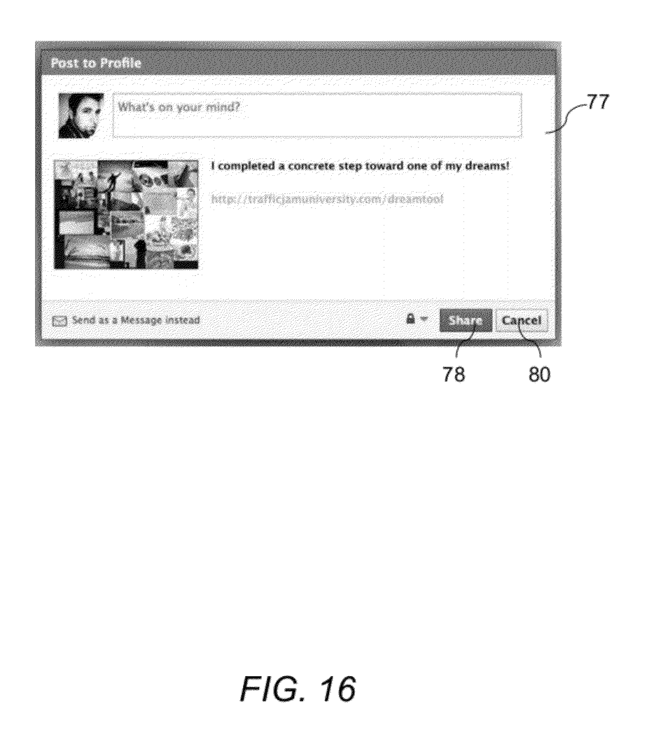

Referring to FIG. 15, each action step panel 70 can contain a graphical button 76 for use in designating an action step 68 as being completed. Once an action step has been completed and a user clicks the graphical button 76 (labeled in FIG. 15 as “I did it!”), a posting screen 77 (see, e.g., FIG. 16) can be automatically displayed to allow the user to enter a thought regarding the completion of the action step, and to decide whether to share the completion to the user's network via one or more online social networking sites. If the user wishes to share a thought and the completion of the action step, then she can select the share button 78. If not, she can select the cancel button 80. If the user elects to share the completion, and selects the share button 78, an announcement is posted in association with the user's online social network profiles, such as, for example, by being posted on a “wall” of the user in FACEBOOK. The posting can be displayed on the wall in connection with a title of the dream (or without connection to a title of dream) to which the action step applies, and an announcement that the user has “completed a concrete step” toward one of the user's dreams. Also, if the user had offered thoughts in the posting screen 77, then those thoughts can be posted on the wall immediately adjacent the announcement of completion.

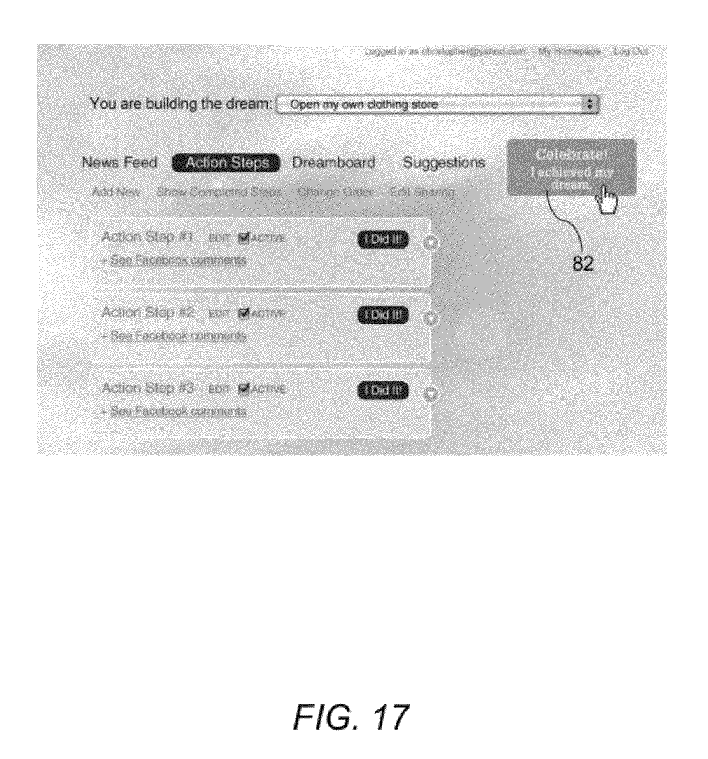

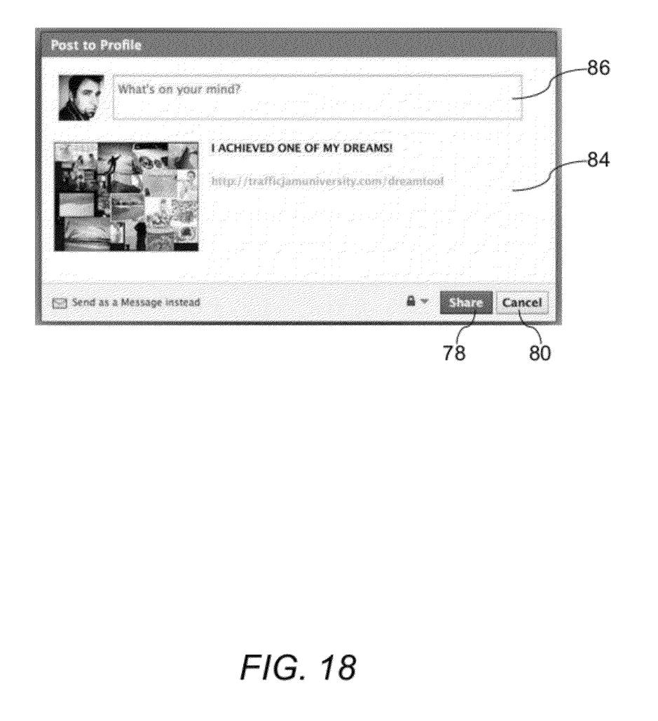

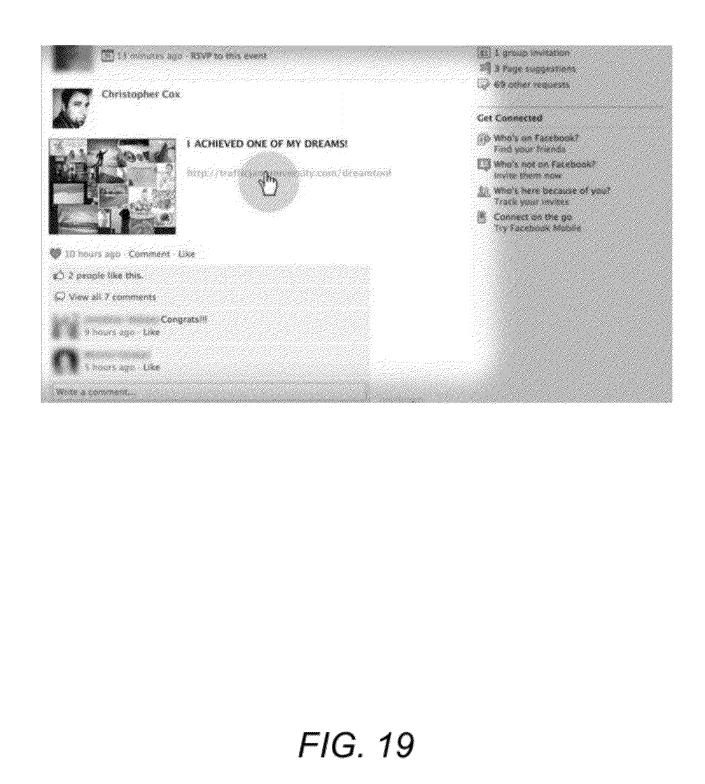

Referring to FIG. 17, when the user accomplishes the dream a posting screen 84 (see e.g., FIG. 18) can be displayed, announcing that the user has “achieved” a dream and providing a field 86 for providing a thought. Again, the user can share the announcement by selecting the share button 78, upon which the announcement can be automatically posted in association with the user's profiles at one or more online social networking sites, such as on the wall of the user's FACEBOOK account, as shown in FIG. 19. The posting of the announcement on the social networking site can be accompanied by a thumbnail image of the user's dreamboard 37 associated with the achieved dream. Third parties, such as friends on FACEBOOK, can then post comments in association with the achievement.

(c) Dreamboard 52:

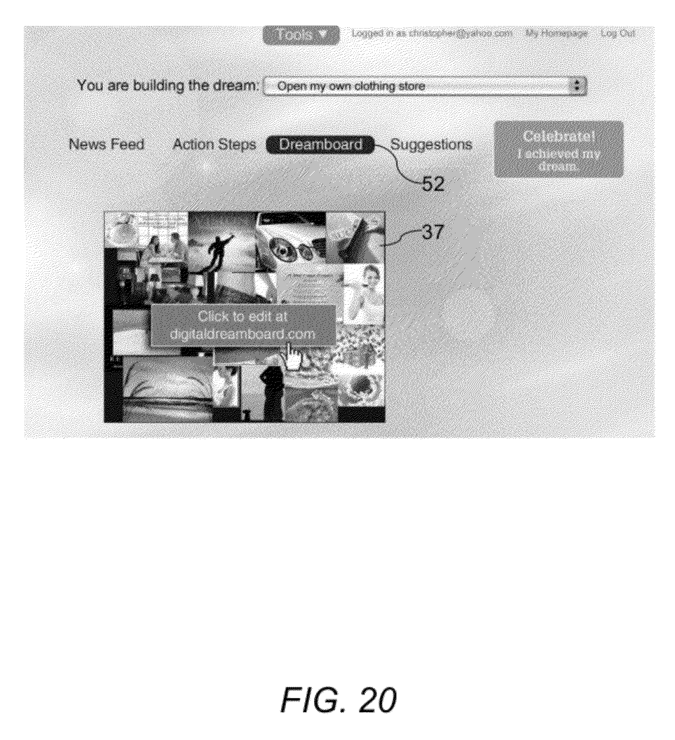

Referring to FIG. 20, in some embodiments, when the Dreamboard 52 indicia is selected, a dreamboard 37 associated with the currently selected dream is displayed. A user can edit the dreamboard to add or remove pictures or text, as will be appreciated by those skilled in the art after reviewing this disclosure. For example, a user can click on the dreamboard to highlight particular images, and delete the image. A user can also click on the dreamboard and a file selection screen can be presented wherein the user can select image files to be uploaded from the user's computer, or from another online location, to the server 4 for inclusion on the dreamboard.

(d) Suggestions 54:

Suggestions can be made by other (third-party) users having accounts established on the system 2 (recognizable by the server 4). Suggestions can be specific to a user's dream and can be privately made to the user (the dream owner).

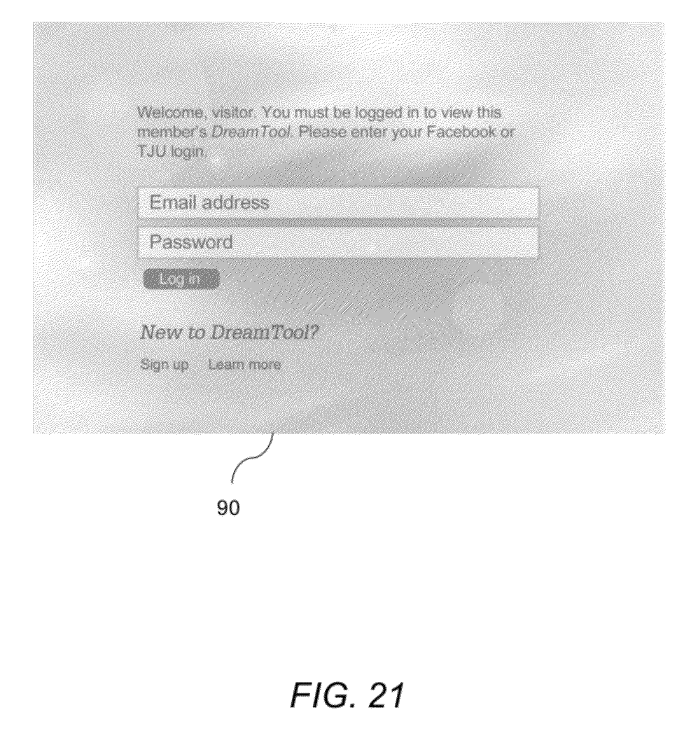

In some embodiments of the present disclosure, when a third-party user of an online social network views a user's dream or action step status or commentary on a social network, such as on a wall posting, a link can be embedded with the status or commentary suggesting that the third-party users make suggestions. If the third-party user activates the link, she can be directed to a login screen 90, such as that shown in FIG. 21. At that log-in screen, the third-party user can either log in, or establish an account on the server 4.

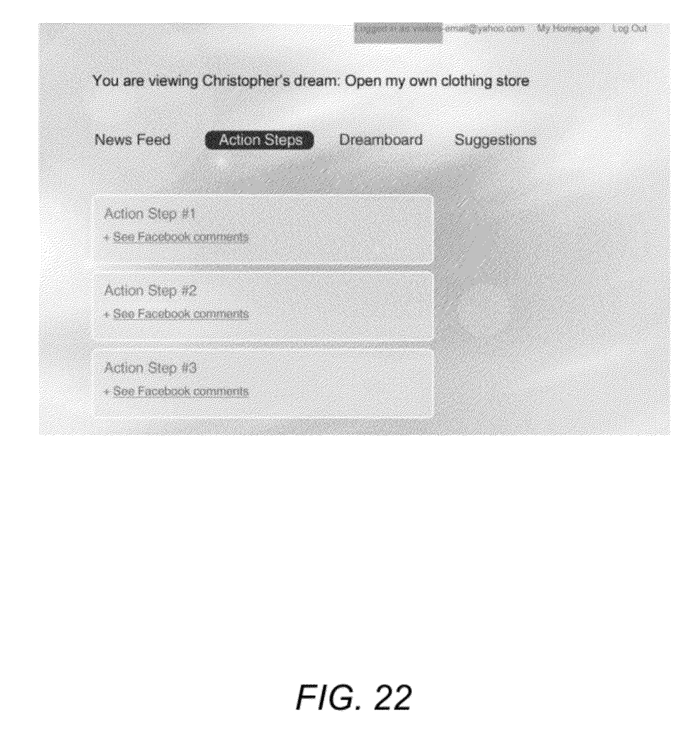

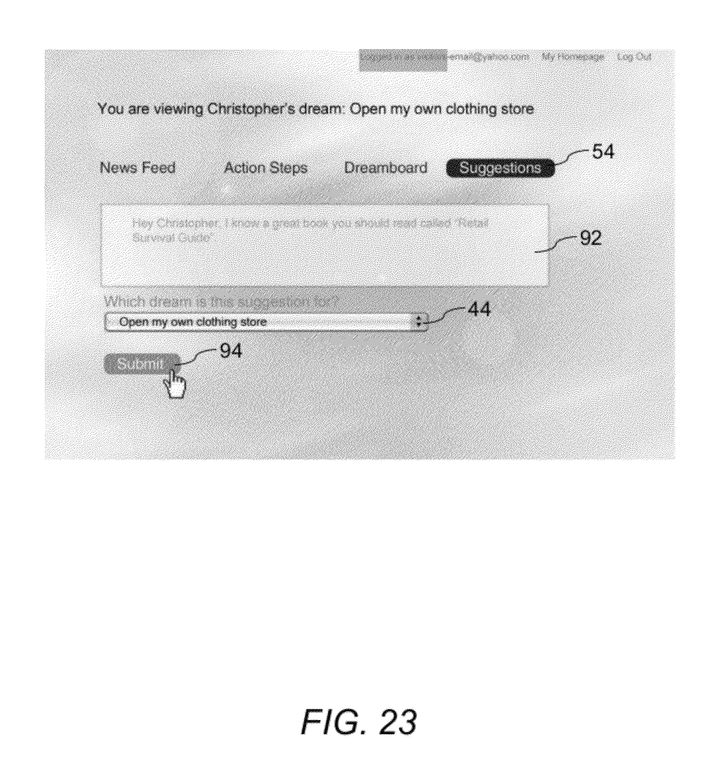

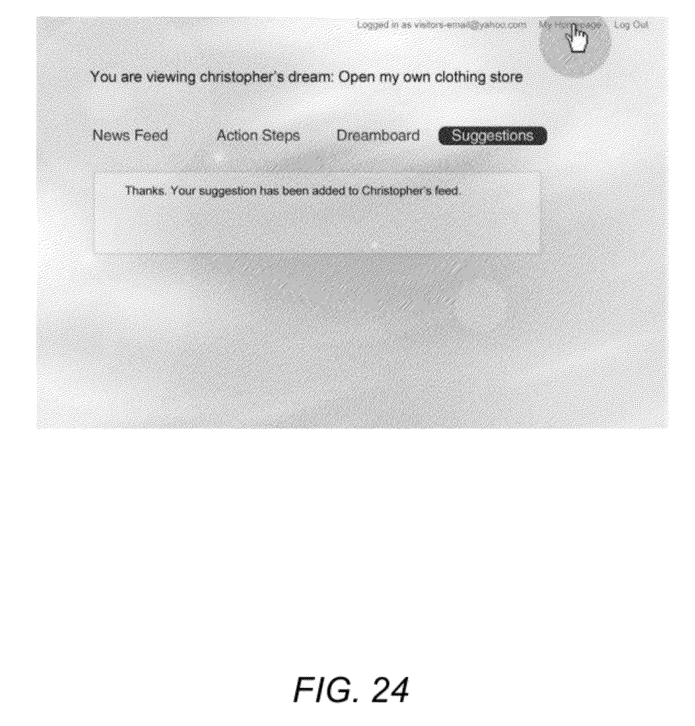

In some embodiments, at the election of the user (dream owner), suggestions for a particular user's dreams can only be made by a third-party if that party has a prior association with the user, such as, for example, without limitation, if the third-party user is a friend of the user on FACEBOOK (or another online social network). The third-party's prior association can be assessed by collecting the third-party's online social network account information or email (e.g., whether the third-party user is a friend can be assessed at the server 4, since the server is able to receive and store a listing of all friends of the user on FACEBOOK, as discussed previously). Referring now to FIG. 22, after the third-party user logs in, the third-party user can view the user's Action Steps, Dreamboard, or News Feed, or other Suggestions, but this can be restricted at the discretion of the user. In some embodiments, the user can set restrictions on different aspects of her account that may be viewable depending on the identity of the third-party user, or can wholly restrict access to certain information on the user's account from access by any third-parties. In some embodiments, where the third-party user is allowed by the user to view at least some of the information associated with the user's account, such as shown in FIG. 22, and wherein the third party user is viewing the user's action steps, the third-party can make suggestions to the user. This can be accomplished by selecting the suggestion 54 button (see, e.g., FIG. 23), which opens a comment field 92 for the third-party user to type a suggestion. In addition, the third party user can select a particular dream for which to leave a suggestion, by scrolling through dreams using the scrollable list 40″ until a dream becomes visible to the liking of the third-party user. The third-party user can then submit her suggestion by selecting the “submit” button 94, after which, she is notified that her suggestion has been submitted. See, e.g., FIG. 24. In some embodiments of the present disclosure, when the user receives the suggestion, a graphical button (not illustrated) is presented to the user the next time the user accesses the server 4, or the next time the user accesses a particular dream to which the suggestion applied, and the button can be selected to initiate an action to add the suggestion to the user's dream as an “action step,” such action step being associated with the same characteristics as other action steps created by the user.

In some embodiments of the present disclosure, the user can specifically designate members of a “support network,” and select that the server 4 only allow those members of the “support network,” to view or access any of the user's information regarding her dreams or action steps, or to make suggestions regarding the user's dreams. This support network can be different in scope than the network with which the user shares information related to dreams or action steps, as discussed above. For example, the user can share information when she elects to post such information to her social network, which can includes the “walls” of all of her user accounts in all online social networks.

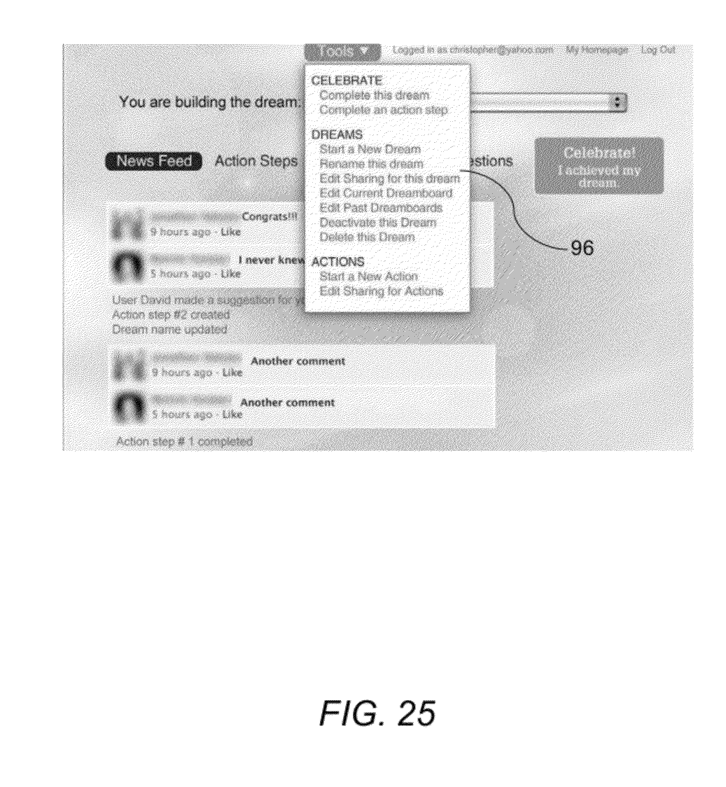

In some embodiments of the present disclosure, a “Tools” menu 96 is provided for a user, such as that shown on the screen displayed in FIG. 25. The Tools menu 96 can allow a user to select from a plurality of actions, including those listed in FIG. 25.

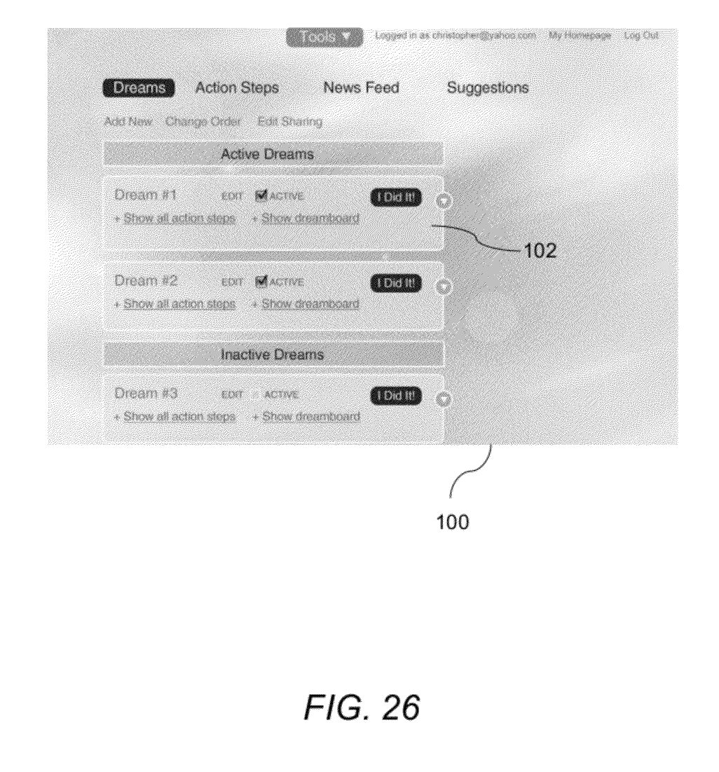

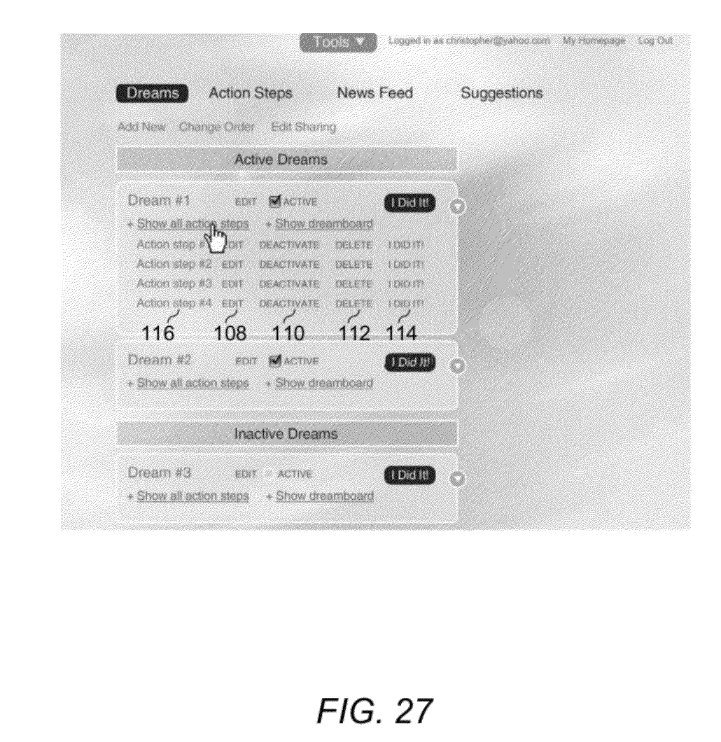

As shown in FIG. 26, in a homepage 100 of the user, the user can select to see the status of her dreams, including all associated action steps and dreamboards. For example, at graphical panel 102, “Dream #1” is shown adjacent two textual indicia, “Show all action steps” 104 and “Show dreamboard” 106. If a user clicks on the “Show all action steps” indicia, the list of action items associated with Dream #1 will be displayed as shown in FIG. 27. Each displayed action step has associated textual indicia for editing 108, deactivating 110, deleting 112, or indicating completion of the corresponding action step 116.

In some embodiments of the present disclosure, the server 4 is configured to send anonymous feeds to third-parties users or users, announcing actions steps created, dreams created, actions steps completed, and dreams achieved, suggestions made to users or by users, etc. These feeds can be selected based on topics or types of dreams, in relation to the recipient of the feed. For example, for third party business websites, anonymous feeds coming from the server 4 could be all related to business-type dreams, etc., or for a user of the system, who has stored dream descriptions relating to family or marriage in a dream title, anonymous feeds related to personal or relationship dreams could be sent to the user. In some embodiments, the identity of individuals associated with these feeds are not transmitted, but in other embodiments, the individuals have the option to set their account settings, such that they allow feeds to contain some identifying information about them, such as first name, or a profile picture of the user.

In some embodiments of the present disclosure, anonymous feeds can pulled from a select group and automatically sent to a particular website affiliate. For example, without limitation, in some embodiments of the present disclosure, an operator of an inspirational dream program, such as a life coach, provides workshops for helping people achieve goals or dreams. The individuals that take that workshop can be provided with a code to enter upon establishing an account with the server 4. Feeds from only users that have associated their accounts on the server 4 with particular code will be sent to a website of the operator of the inspirational dream program. This can allow the operator to view how their clients are progressing in managing dreams. In some embodiments, the feeds are fed anonymously to the affiliate web site without revealing any of the specific user identities from whom particular feeds emanate.

A system and method has been described enabling a user to, among other things, establish an account that helps identify and record dreams and actions steps to accomplish those dreams, provide a support network to help drive the user toward those dreams, including receiving suggestions from the support network, publish accomplishments made in attaining those dreams, and publish achievement of those dreams.

In some embodiments of the present disclosure, the system provides graphical user interface modes wherein a user is able to set deadlines for any action step or goal, wherein the deadlines set can be designated by a user to be automatically sent by the server 4 to an external calendar system (e.g., OUTLOOK™ or GOOGLE™ calendar systems). The user can also designate other users of the system 2 to establish a pre-designated accountability group, the accountability group members having access to view particular selected action steps or dreams of the user for which the accountability group members were selected by the user (or coach, as described below), and any associated deadlines for those actions steps or dreams. If the deadlines are met, not met, or changed, the accountability group members may receive notification and be able to send messages to the user. In some embodiments, the user can also designate different groups of individuals in the user's network. The user can then elect to send different dreams, actions steps, or accomplishments to any of the various groups.

In some embodiments of the present invention, the life coach, or coach, can use a computer to access a server, such as server 4, to establish an account and access a coach-side graphical user interface (“GUI”) of the present disclosure. The coach-side graphical user interface may be configured to have different modes, and in some modes, a coach can view clients' current goals (e.g., dreams), actions steps and past accomplished action steps or dreams. That is, the coach may have access to this information from a user's (e.g, client's) account. In some embodiments, the coach-side graphical user interface for the coach may provide an administrative capability for the coach to establish new accounts for trainees or clients (e.g., users of the system 2), in which case, the coach's account may have pre-designated permission to access and monitor the status of certain parameters of the client's account, such as current dreams, actions steps, and past accomplished actions and goals. In some embodiments, the clients will have the capability to disassociate with the coach's account to terminate the coach's access rights to parameters of the client's account, but the default initially may be to allow the coach to access and view such parameters. In other embodiments, clients may establish their accounts separately as users, and may elect to affiliate with a coach's account, or the coach may select to request permission from their clients to have access to monitor those parameters, and clients may grant such permission from their separate accounts. In further embodiments, the parameters that a coach can monitor include other information, such as, for example, the comments of others user regarding a particular client (e.g., those in the client's groups).

In some embodiments, the coach can request to associate the coach's account on server 4 with a list of clients on one or more online social networks, such as, for example, without limitation, FACEBOOK™. In some embodiments, the coach can require all clients to have accounts established with the server 4, so that all of the coach's clients can receive the benefits of this present disclosure. In some embodiments, the coach can use the coach side graphical user interface to view selected groups of clients from the coach's FACEBOOK account, to view particular parameters for clients of those groups. The coach side graphical user interface can allow the coach to sort and view users based on particular parameters such, for example, recently active clients, last actions completed by clients, etc. In various embodiments, the coach can also access further information related to the client's activities, such as, for example, any of the aforementioned parameters or information described supra that users provide within their respective accounts.

In some embodiments, the coach can send a group report to particular groups designated by the coach, providing status updates for members of that group. The status updates can be viewed by all members of the group, and can include information selected by the coach, such as, for example, action steps or goals, and associated upcoming deadlines for individual group members, and completed actions for group members. This can help drive group members by aiding in providing accountability.

In some embodiments of the present disclosure, the coach-side graphical user interface includes selectable modes to allow a coach to view reports regarding clients. The reports can be, for example, condensed summaries of client status and other information, such as, for example, last login, last action step created, last action completed, recent comments, etc. In some embodiments, a note mode of the coach-side graphical user interface can include a graphical notepad wherein a coach can write and save notes associated with reports regarding the client. In some embodiments, the reports are sent to the coach via email, or via the coach's account on the server 4.

In some embodiments, the coach can select to automatically send notifications to clients on a timed basis, or as a function of client activity. The notifications can be, for example, congratulatory notes for achieving actions or goals (e.g., conditioned on accomplishment of action steps or goals that are monitored), or reminders for completing certain actions (e.g., conditioned on timers or particular time events occurring, such as a particular calendar day) or reminders for making calls with the coach as part of the client's coaching program. In addition, coaches can receive notification when users or clients elect to affiliate their accounts with the coach's account.

In some embodiments of the present invention, the coach may have a publicly viewable page associated with the coach's account. Information may be displayable on the publicly viewable page as a “feed” from client accounts associated with the coach. For example, a coach may select to have client actions and/or goals (with client's permission) fed to the coach's public page, along with notification of completed actions and/or goals. In some embodiments, the feeds are anonymous and not publically displayed in association with any particular user. In some embodiments, statistical information is also displayable on the coach's page, showing, for example, completion rate of goals or actions related to the clients, number of actions or goals completed within a period of time, etc. This can encourage other viewers to desire to affiliate with the coach.

In some embodiments, each user, which may include clients and coaches, or one or the other, can have a display associated with their account that rates the user's interaction activities with other users, and the user's association with accomplishments achieved by other users. For example, in some embodiments, various activities of the user are associated with numerical ratings. For example, without limitation, in some embodiments, if a user writes a suggestion to another user regarding the other user's goal, the user could earn a numerical rating of 0.3, while if the goal is actually achieved by the other user and reported by the other user, the user that made the suggestion could be assigned another numerical rating of 1.0, etc, with each of the numerical ratings being aggregated together to achieve a total numerical rating. The total numerical rating could be displayable on a page associated with the user writing the suggestions. Also, in other embodiments, a user's own actions and accomplishments can also add to the user's total numerical rating. For example, if a user writes an action step, the user can be assigned a numerical rating of 1.0, while if a user accomplishes the action step, the user can be assigned another numerical rating of 5.0, and if the user accomplishes the goal or dream associated with the action step, the user can be assigned still another numerical rating of 10.0. The example ratings provided above, their numerical weights, and actions rated are only non-limiting examples. The aggregate numerical rating, or total numerical rating, earned by a user can be displayed in association with the user to other users, so that others can see the user's total rating. In some embodiments, the total numerical rating can be displayed publicly, in association with the user, such as on a public account page for the user, or on page that displays a plurality of users and their associated total numerical ratings. In some embodiments, users can select to hide their total numerical ratings, or select to have their total numerical ratings only viewable by certain groups of users selectable by the user. In some embodiments, the total numerical ratings can be based on the total time the user has had an account with the server 4, or can be based on recent activity within a given timeframe (e.g., 1 year, 2 years, 1 months, 2 months, etc.).

In further embodiments, coaches can select to be associated with client-based numerical ratings. Client-based numerical ratings can be an average of the aggregate of total numerical ratings for all clients of the coach. For example, the total numerical ratings of each of the clients can be added together and divided by the number of clients, to arrive at the client-based numerical rating for the coach. The coach can select to display his or her client-based numerical rating publicly, or otherwise, in association with the coach's account for others to see. To some viewers, the client-based numerical rating can serve as a partial measure of the coach's effectiveness.

Although specific embodiments and examples of the disclosure have been described supra (and in the attachments) for illustrative purposes, various equivalent modifications can be made without departing from the spirit and scope of the disclosure, as will be recognized by those skilled in the relevant art after reviewing the present disclosure. The various embodiments described can be combined to provide further embodiments. The described systems and methods can omit some elements or acts, can add other elements or acts, or can combine the elements or execute the acts in a different order than that illustrated, to achieve various advantages of the disclosure. These and other changes can be made to the disclosure in light of the detailed description (including attachments).

In general, in the following claims, the terms used should not be construed to limit the disclosure to the specific embodiments disclosed in the specification. Accordingly, the inventions herein are not limited by the disclosure, but instead, their scope is determined entirely by the following claims.

1. A computer implemented method for monitoring and encouraging the attainment of personal dreams for a user comprising:
providing a text field for use in describing a dream;
storing a written description of the dream as entered in the field;
providing a plurality of text fields for use in describing action steps for attaining the dream;
storing a plurality of written descriptions, as entered in the text fields, each description describing a different action step for attaining the dream, the plurality of descriptions of action steps all being stored in association with the description of the dream;
providing a graphical selector for each action step for use in designating when the action step is complete, the graphical selectors being displayable proximate the corresponding description of each action step; and
providing a field for use by a third-party user for entering suggestions related to the dream or each action step, and storing that suggestion in association with the dream or corresponding action step.

2. The computer implemented method of claim 1 further comprising:
prompting the user to create an image to be associated with the description of the dream; and
storing the digital image in association with the description of the dream.

3. The computer implemented method of claim 1 wherein each action step, including information on whether the action step is complete, can be published to one or more online social networks.

4. The computer implemented method of claim 1 wherein each dream, including information on whether the dream is achieved, can be published to one or more online social networks.

5. The computer implemented method of claim 4 wherein the published dream can be published in conjunction with a link that can be accessed by third-party user to redirect the third party user to a web page on which the third-party user can provide a suggestion to the user.

6. The computer implemented method of claim 5 wherein before the third-party user can provide a suggestion, the third-party user must establish an account on the server.

7. The computer implemented method of claim 1 wherein the user can selectively designate access and restrict access to and from third party users for viewing the description of the dream, descriptions of the actions steps, and whether the graphical selectors for designating completion of actions steps have been selected.

8. The computer implemented method of claim 1 further comprising:
providing a graphical button in association with the suggestion, wherein when a user actuates the graphical button, the written description of the suggestion is converted to an action step that can be displayed in association with a graphical selector for use in designating when the action step is complete.

9. The computer implemented method of claim 1 wherein the user can select to view an indicia associated with the dream, and indicia associated with all actions steps for the dream, any status indicators for the actions steps, all suggestions related to the dream or actions steps, all comments related to the dream or actions steps, and all indications of achievement of the dream or actions steps.

10. The computer implemented method of claim 1 wherein the user can select to view example dream descriptions gathered from other users' dream descriptions.

11. The computer implemented method of claim 10 further comprising displaying example dream descriptions to the user when the field for providing dream description is being displayed for more than a pre-designated period of time without completion by the users.

12. The computer implemented method of claim 1 wherein the user can select to view example actions step descriptions gathered from other users' action step descriptions.

13. The computer implemented method of claim 12 further comprising displaying example action step descriptions to the user when the field for providing action step descriptions is being displayed for more than a pre-designated period of time without completion by the user.

14. The computer implemented method of claim 1 wherein at least one of the user's dream descriptions, status indications for the dreams, action step descriptions, or status indications can be anonymously fed to one or more third party websites or to other users.

15. The computer implemented method of claim 10 wherein the third party websites to which the anonymous feeds are provided are determined based on an identity of the user.

16. A system for monitoring and encouraging the attainment of personal dreams for a user comprising:
a plurality of user computing devices;
at least one hosting computing device in communication with the plurality of user computing device, the hosting computing device having a processor operable for use in displaying a graphical user interface for use in:
receiving a first dream description from a user describing a first dream, and storing the description;
receiving descriptions for a plurality of actions steps for use in achieving the first dream and storing the actions steps;
displaying a graphical scroll for use in selecting a dream description;
displaying a plurality of graphical indicia representing different displays;
selecting one of the plurality of graphical indicia representing a display of the action steps and displaying the plurality of actions steps in sequential order of required performance, with each action step being visually associated with a graphical indicia selectable for designating completion of the action step; and
designating one of the action steps as being completed, wherein the host computing device automatically causes displays of a graphical posting screen having a text field for use in commenting on completion of the action step and having a graphical selector for use in selecting to publish an announcement of completion of the action step to one or more online social networks.

17. The system of claim 16 wherein when the action step is published to the online social network, third-party comments made on the social networks in association with the publish action step are fed back to the user to be displayable in association with the action step.

18. The system of claim 16 wherein when the action step is published, a link is published proximate the action step which can be selected by third-party users to view the user's dreams and action steps

19. The system of claim 18 wherein the third-party user must first establish a new server account before the third party user can view the user's dreams and actions steps.

20. The system of claim 16 wherein the user can select privacy settings to restrict access of the third-party user to viewing the users' action steps or dreams.

21. The system of claim 16 wherein the third party can post text-based suggestions in relation to a dream or action step to be displayed to the user, and wherein the user can select to convert the suggestions to action steps.

22. The system of claim 16 wherein the computing device causes the display of a plurality of sample dream descriptions to the user, to assist the user in textually describing a dream, the sample dream descriptions being at least partially comprised of dream descriptions provided by other users.

23. The system of claim 22 wherein the plurality of sample dream descriptions are displayed automatically if a user does not enter a dream description after a pre-designated period has elapsed.

24. The system of claim 16 wherein the computing device causes the display of a plurality of sample action step descriptions to the user, to assist the user in textually describing an action step, the sample action step descriptions being at least partially comprised of actions steps provided by other users.

25. The system of claim 24 wherein the plurality of sample action step descriptions are displayed automatically if a user does not enter an action step after a pre-designated period has elapsed.

26. The system of claim 16 wherein at least one of the actions steps, dreams, the status of actions steps, the status of dreams, comments made in connection with action steps and dream, and suggestions made in connection with actions steps and dreams, are fed anonymously to third party websites.

27. The system of claim 26 wherein the particular third party websites to which the information is fed anonymously are a function of the identity of the user.

28. A computer implemented method for monitoring and encouraging the attainment of personal dreams for a user comprising:
providing a text field for use in describing a dream;
receiving a written description of the dream as entered in the field;
providing a plurality of text fields for use in describing action steps for attaining the dream;
receiving a plurality of written descriptions, as entered in the text fields, each description describing a different action step for attaining the dream, the plurality of descriptions of action steps all being stored in association with the description of the dream;
providing a field for use in indicating a status associated with one or more of the written descriptions; and
automatically transmitting a current status associated with one or more of the written descriptions to a third-party coach's account.

29. The computer implemented method of claim 28 further comprising generating a report for a coach's account summarizing, for one or more users, activity associated with the user's account.

30. The computer implemented method of claim 29 wherein the activity summarized includes at least one of actions steps accomplished, deadlines expired, dreams accomplished, last login date, last action step created, last dream described.

31. The computer implemented method of claim 29 further comprising sending the report automatically on a daily basis to the coach.

32. The computer implemented method of claim 28 further comprising automatically sending notifications selected by the coach to the user, the notifications comprising at least one of deadlines for action steps or goals, reminders for calls with the coach, or notes from the coach to the user.

33. The computer implemented method of claim 28 further comprising assigning a group of other users to form an accountability group for at least one written description wherein the other users can view deadlines associated with the written description.

34. The computer implemented method of claim 33 wherein the user can have different accountability groups associated with different written descriptions, the different accountability groups comprising different other users.

35. The computer implemented method of claim 28 further comprising displaying a numerical rating associated with at least one user, the numerical rating being generated as a function of at least one of user interaction with other users, user accomplishments, and accomplishments of other users with which user interacts.

36. The computer implemented method of claim 35 further comprising displaying at least one client-based numerical rating in association with a coach, the client-based numerical rating being a function of a plurality of numerical ratings associated with different users.
